(19) United States
(12) Patent Application Publication
(10) Pub. No.: US 2017/0270579 A1
(43) Pub. Date: Sep. 21, 2017

(54) ROBOTIC EQUIPMENT FOR THE LOCATION OF ITEMS IN A SHOP AND OPERATING PROCESS THEREOF

(71) Applicants: Tier1 Technology, S.L., Camas (ES); UNIVERSIDAD DE SEVILLA, SEVILLA (ES)

(72) Inventors: Miguel Angel RIDAO CARLINI, SEVILLA (ES); Carlos BORDONS ALBA, SEVILLA (ES); Eduardo FERNÁNDEZ CAMACHO, SEVILLA (ES); Gonzalo HERNÁNDEZ RODRÍGUEZ, SEVILLA (ES); Francisco Javier RUBIO GONZÁLEZ, SEVILLA (ES); José Luis CORDERO AMARILLO, SEVILLA (ES)

(21) Appl. No.: 15/217,479

(22) Filed: Jul. 22, 2016

(30) Foreign Application Priority Data
Mar. 15, 2016 (ES) 201630307

(51) Int. Cl. G06Q 30/06; G05D 1/00; G05D 1/02; G06Q 10/08; G06K 7/10

(52) U.S. Cl. CPC G06Q 30/0613; G06Q 10/087; G06Q 30/0639; G06K 7/10861; G05D 1/0272; G05D 1/0248; G05D 1/0022; G05D 1/0225; Y10S 901/01

(57) ABSTRACT

Robotic equipment for the location of items in a shop, in the XYZ coordinates, which is equipped with a mobile robot 1 and may optionally comprise an external computer 2 wirelessly connected to the robot 1, which, in turn, is composed of an artificial vision system 3, a scanning and obstacle detection system 4, an active tag reader system with optical and/or electromagnetic signals 5, a motion system 11 formed by at least two driving wheels, a battery 6 and a controller 7, which comprises a main plate with an open-source operating system, said controller being connected to the different systems that make up the robot and configured so as to receive data from said systems and process them in order to create a map of the shop and determine the location of all the items in the shop.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from Spanish application no. 201630307 filed Mar. 15, 2016 entitled, “ROBOTIC EQUIPMENT FOR THE LOCATION OF ITEMS IN A SHOP AND OPERATING PROCESS THEREOF”.

### DESCRIPTION

Technical Field of the Invention

The present invention is framed within robotic equipment and systems capable of interacting with their surroundings. In particular, the present invention relates to an autonomous robotic equipment designed to help consumers or employees to locate items in a shop in a quick, simple manner.

Relevant Art

A robot is an electronic machine that may be programmed to move or perform certain operations. In recent years, advances in microelectronics and the development of computer science have made it possible to develop increasingly complex robots, capable of performing tasks and operations formerly reserved only to persons.

In regards to shop assistant robotic systems, US Published Application No. 20040217166 discloses a device that guides the shopper inside a shop, using a robotic cart that contains the shopping list. However, the way in which the robotic cart is to be able to locate the objects has not been resolved.

Currently, there are patents related to the positioning of a robot, the navigation thereof in structured or unstructured environments, etc., but their implementation cost is quite high and, at best, they are only capable of locating items horizontally, at ground level.

There are also automated dispensing systems and warehouses (e.g., U.S. Pat. No. 6,325,586) capable of storing an object and later recovering it, but they are all based on the assumption that the exact location of the item is known. There have also been developments in relation to packaging the purchased items in cardboard boxes (see US Published Application Nos. 20150059286, 20140180479). Some of these warehouses may offer customers the completed purchase when they supply a list of requests, but by taking the items from a warehouse that is closed to the public (see US Published Application No. 20050238465).

On the other hand, there are robotic systems that interact with humans (see U.S. Pat. No. 6,584,375), but in general they are very simple interfaces which are limited to exchanging certain phrases and gesticulating. These systems are not capable of locating objects, except under extremely controlled conditions.

Another very important disadvantage of the currently existing robotic systems for shops is their high cost, which is impossible to afford by a store chain.

The present invention describes a robotic equipment that makes it possible to locate the items in a shop such that the customers or consumers may obtain them as quickly as possible. The equipment of the invention facilitates the task of shopping by locating the items on a shelf (both horizontally and vertically, by setting up a spatial location with coordinates on the XYZ axes), thereby allowing for an assistant system to help the final consumers to quickly find the items in their shopping list. In this way, it is not necessary to automate a complete shop, which would have a very high implementation cost.

### SUMMARY

The invention involves a robotic equipment that is capable of locating items in racks or shelves in retail shops, although the application thereof to other types of larger or wholesale establishments is not excluded.

The robotic equipment comprises a mobile robot with autonomous odometry navigation that may move throughout the shop and locate the items located on the shelves thereof by means of artificial vision. The items are identified by means of codes, whether barcodes, QRs (Quick Response Codes), RFID (an acronym for Radio Frequency Identification), and/or optical signals, and may be at any height of the rack or shelf. The robot makes a map of the shop in order to identify the location of the racks and, subsequently, by reading the identification codes of the items and auxiliary signals originating from active tags, identifies all the items, both horizontally and vertically, thereby creating a map with the location of each item. Once the location of the different items is known, the robot may search the items requested by the customers.

In order to be able to perform these actions, the robotic equipment of the present invention comprises a mobile robot equipped with the following elements or devices:
an artificial vision system for the capture of images,
a scanning and obstacle detection system composed of at least one laser sensor,
an active tag reader system with optical and/or electromagnetic signals,
a motion system formed by at least two driving wheels,
a battery that allows the robot to operate in an autonomous manner,
a controller that comprises a main plate with an open-source operating system (for example, ROS, robot operating system), said controller being connected to the artificial vision system, the scanning and obstacle detection system, the tag reader system and the motion system, and configured so as to receive data from said systems and process them in order to create a map of the shop and determine the location of each item.

The robot may include a charging dock to recharge the battery when it is empty.

Moreover, the mobile robot may include at least one articulated robotic arm which is also connected to the controller, the free end whereof is equipped with gripping means in the form of clamps or similar. In this case, the controller is configured so as to transmit instructions to the robotic arm such that it may collect the items.

The robot preferably includes a load platform which allows for it to be used as an assistant in the transport of items for the customers, such that said customers may deposit said items on the platform whilst doing their shopping.

The laser used in the scanning and obstacle detection system is preferably a LIDAR-technology (Laser Imaging Detection and Ranging) laser; this is a technology that makes it possible to determine the distance between a laser emitter and an object or surface using a pulsed laser beam. This type of lasers provides very reliable measurements due to their high precision in the measurements and their high angular resolution. The laser will allow the robot to draw the map of the shop and detect obstacles.

The active tag reader system with optical and/or electromagnetic signals preferably comprises an RFID (Radio Frequency Identification) radiofrequency tag reader; ultra-high frequencies (UHF) may be used due to its greater reading distance and speed; moreover, the greater directionality of the tag emission beams makes it possible to locate the products with greater precision. It is also possible to use a high-frequency (HF) reader. The active tag reader system with optical signals may be a vision camera or an optical sensor.

Preferably, the artificial vision system comprises a photographic camera, or webcam, and an infrared sensor. Thanks to the artificial vision system, the robot may take a large number of photographs per second of a shelf and these images will be processed in real time.

The controller may be a netbook controller (laptop), since these controllers are economical and have an acceptable power.

In the event that the robot controller does not have sufficient computational capacity, the robotic equipment may comprise an external computer wirelessly connected (wireless, wimax, XG, etc.) to the mobile robot. In this case, the robot would be configured so as to send the data (captured images) collected to the conveniently programmed external computer, which would perform the treatment and processing thereof in order to obtain the location of the items in the shop (both in the vertical and horizontal positions within a shelf or rack) and save them in a database. The external computer would simply execute those algorithms that require many computational resources.

Once they have been processed by the external computer, the data may be sent once again to the mobile robot or stored in the external computer database, if the latter is integrated with an ERP (Enterprise Resource Planning) software. In order to identify all the items on a shelf in a shop, the mobile robot, which navigates using odometry, stands parallel to the shelf using its laser sensor. To this end, it uses the identification codes associated with each product. The items are identified by means of artificial vision, by analysing the images obtained when the robot travels parallel to the shelf, using the information supplied by the active tags and the identification codes. The robot calculates the location of each item in absolute coordinates (XYZ) at the shop level.

The robotic equipment thus conceived makes it possible to locate products placed at any height of a shelf and remember the location thereof. Moreover, it is preferably based on the most widely spread, low-cost identifier in the retail sector, i.e. the barcode. The robot, which moves using odometry, creates a map of the shop as it travels through it, thanks to its laser sensor, and is equipped with obstacle detection and avoidance algorithms, which allow it to navigate autonomously in order to access the desired items.

The potential applications of the invention are in the retail shop sector, in the massive commercialisation of products or services to large numbers of final consumers, in enterprises in the catering, restaurant and coffee-shop sectors, and even in industry. It has potential applications in any environment wherein items need to be located within storage systems.

It may be applied to any manufacturing industry wherein it is necessary to locate items that may be identified by means of tags based on different technologies.

### DESCRIPTION OF THE FIGURES

In order to contribute to a better understanding of the present invention, the following figures are included for illustrative, non-limiting purposes:

FIG. 1 shows the robotic equipment of the present invention in front of a shelf in a shop.

FIG. 2A shows a profile view of the mobile robot.

FIG. 2B shows a front view of the mobile robot.

FIG. 3 shows a flow diagram of a preferred embodiment of the operation of the robotic equipment, which comprises a mobile robot and an external computer, or PC.

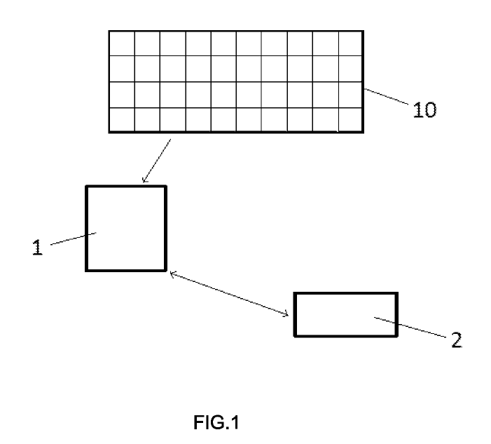

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

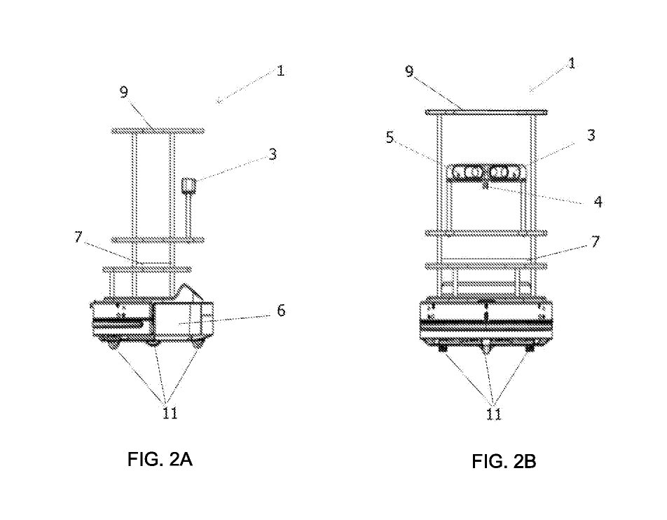

In a particular embodiment, the robotic equipment of the present invention is made up of a mobile robot 1 and an external computer, or PC 2, which is wirelessly connected to the mobile robot. As shown in FIG. 2, the mobile robot 1, which navigates using odometry, comprises an artificial vision system 3 for the capture of images, barcodes and QRs, or any other coding of items that may be graphically treated. Said artificial vision system may comprise a webcam, an infrared sensor, a barcode reader and/or a QR code reader. The mobile robot further comprises a scanning and obstacle detection system 4 formed by a LIDAR-technology laser, which the robot uses to draw the map of the shop whilst it navigates and to avoid obstacles, an active tag reader system 5, which comprises an RFID reader (radiofrequency reader), and a motion system 11 formed by at least two driving wheels. Moreover, the robot includes a battery 6, which will give it autonomy for several hours. The robot is further equipped with a programmable controller 7, which has a main plate with an open-source operating system, and a charging dock to recharge the battery when it is empty. The controller 7 is configured so as to receive data from the different systems that make up the robot (artificial vision, scanning and obstacle detection, active tag reader and motion systems); the robot sends the data to the external computer 2 such that they may be processed and a map of the shop and the location of the items may be drawn.

To this end, the items in the shop must be equipped with identification codes. The identification codes may be: barcodes or QR (Quick Response Code) codes, both of which are detected by the artificial vision system, RFID (Radio Frequency Identification) codes, and/or codes with optical signals, which would be detected by an active tag reader system with optical and/or electromagnetic signals.

The robot 1 includes a platform 9, where the customer may deposit the selected items.

The robot 1 may further include an articulated robotic arm (not represented), also connected to the controller, the free end whereof is equipped with gripping means, such as clamps or similar.

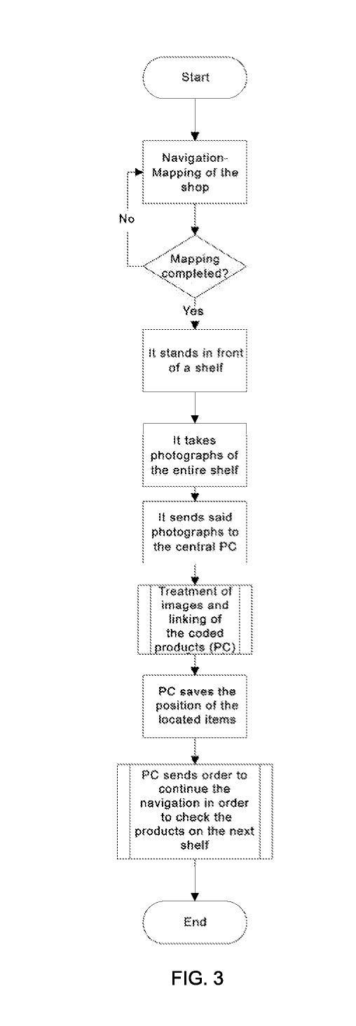

The operating process of the robotic equipment that comprises a mobile robot 1 and an external computer 2 for the location of items in a shop equipped with shelves where the items are placed comprises the following steps (see FIG. 3):
the mobile robot 1 navigates, using odometry, throughout the shop, drawing a map thereof in order to determine obstacles, shelves, etc., by using a laser scanning and obstacle detection system,
once the map of the shop is known, the robot 1 stands in front of a shelf 10 thereof and performs a second navigation in order to detect the products placed on said shelf 10 by means of the active tag reader system 5 and/or the artificial vision system 3, thereby obtaining data and/or images of the shelf and its items.
the robot 1 sends the data received from the different systems to the external computer 2, which is configured so as to process said data in order to calculate the location of each item in the form of absolute coordinates XYZ at the shop level, as well as to save the location of the items in a database (the external computer 2 software will previously have the code-product relationships, such that it may link each code to the corresponding product),
the external computer 2 sends an order to the robot 1 to detect the products on another shelf, and so on, until it has a complete map of the shop with all the products located.

In the event that the robotic equipment does not include an external computer 2, the mobile robot 1 controller 7 would be in charge of processing the data collected, in order to calculate the location of the items in the form of absolute coordinates XYZ at the shop level, and would save their location in a database in the controller 7 itself. Moreover, in this case, the controller software will previously have the code-product relationships.

When a customer requests a product from the robot (for example, through a point of sale or user interface), it consults the database in the external computer 2 or the robot controller 7 and move to where the requested item is located.

1. Robotic equipment for the location of items in a shop, the items being equipped with identification codes, characterised in that it comprises a mobile robot that navigates using odometry and which, in turn, comprises the following elements:
an artificial vision system for the capture of images comprising a webcam, an infrared sensor, a barcode reader and/or a QR code reader,
a scanning and obstacle detection system composed of at least one laser sensor, which is used to draw the map of the shop,
an active tag reader system with optical and/or electromagnetic signals,
a motion system formed by at least two driving wheels,
a battery that allows the robot to operate in an autonomous manner,
a controller, which comprises a main board with an operating system, said controller being connected to the artificial vision system, the scanning and obstacle detection system, the active tag reader system and the motion system, and configured so as to receive data from said systems and process them in order to create a map of the shop and determine the location of each item in the shop in the form of coordinates XYZ.

2. Robotic equipment, according to claim 1, comprising an external computer wirelessly connected to the robot.

3. Robotic equipment, according to claim 1, wherein the mobile robot includes an articulated robotic arm connected to the controller, the free end whereof is equipped with a gripper.

4. Robotic equipment, according to claim 1, comprising a charging dock to recharge the battery.

5. Robotic equipment, according to claim 1, wherein the laser used in the scanning and obstacle detection system is preferably a LIDAR-technology laser.

6. Robotic equipment, according to claim 1, wherein the active tag reader system comprises a radiofrequency tag reader.

7. (canceled)

8. Robotic equipment, according to claim 1, wherein the robot comprises a platform designed for depositing selected items.

9. A process of locating items equipped with identification codes in a shop containing shelves comprising:
a mobile robot navigating, using odometry, throughout the shop, drawing a map thereof using scanning and obstacle detection,
the robot navigating to a shelf in the shop and then detecting the items on the shelf using one or both of an active tag reader system or an artificial vision system.

10. A process according to claim 9 further comprising:
the robot wirelessly sending data representative of the map and the detected items to an external computer,
the external computer processing the data in order to calculate the location of each detected item in the form of absolute coordinates XYZ at the shop level and saving the location of the items in a database,
the external computer sending orders to the robot to detect the items on successive shelves to obtain a complete map of the shop with all its products located.

11. A process according to claim 9 wherein the mobile robot includes a controller which processes the data obtained in order to calculate the location of the items in the form of absolute coordinates XYZ at the shop level and saves the location of the items in a database in the controller itself.
